(19) United States
(12) Patent Application Publication
(10) Pub. No.: US 2007/0148358 A1
(43) Pub. Date: Jun. 28, 2007

(54) APPARATUS AND METHOD FOR MANUFACTURING SURFACE PROTECTION FILM WITH A TOPCOAT

(75) Inventor: Douglas Worthen, Lowell, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: WORTHEN INDUSTRIES, Nashua, NH (US)

(21) Appl. No.: 11/557,793

(22) Filed: Nov. 8, 2006

Related U.S. Application Data
(60) Provisional application No. 60/734,503, filed on Nov. 8, 2005.

(51) Int. Cl. B05D 7/00

(52) U.S. Cl. 427/407.1

(57) ABSTRACT

A method of manufacturing a surface protection film for protecting an exposed surfaces from harsh environments weathering may comprise coating a carrier film with a topcoat layer, extruding a polyurethane layer directly onto an exposed surface of the topcoat layer such that the polyurethane film and the topcoat layer bond together without the need to perform a separate lamination step, and applying an adhesive layer to a surface of the polyurethane layer generally opposite a side bonded to the topcoat layer. According to one embodiment, the polyurethane layer may be extruded directly onto the topcoat layer at a temperature between approximately 250-450° F. the present disclose may eliminate the need to separately laminate the topcoat and the polyurethane, thereby making the process more cost effective.

### CROSS REFERENCE TO RELATED APPLICATIONS

This application claims the benefit of U.S. Provisional Patent Application No. 60/734,503, filed Nov. 8, 2006 which is hereby fully incorporated by reference.

### TECHNICAL FIELD

The present disclosure relates to protective films and more particularly, relates to method of manufacturing protective films having a topcoat.

### BACKGROUND INFORMATION

Surface protection films 1, FIG. 1, may be made from polyurethane and may be used to protect land or marine craft exteriors from harsh environments and weathering. Polyurethane may be used in surface protection environments because, in part, of its high abrasion resistance, UV resistance, elongation, resistance to chemicals and fungus, and ease of fabrication. Surface protection polyurethane films 1 are most commonly known for their automotive applications, yet have recently found many useful applications in several other markets.

Surface protection films 1 may have a topcoat 2 disposed on a first surface 3 (i.e., the exposed surface) of a layer of polyurethane 4 and adhesive 5 on the second or lower side 6 of the polyurethane layer 4. While some applications do not require a topcoat 2, the topcoat 2 may be applied to help such properties as stain resistance, UV resistance, gloss and impact resistance.

One method 200, FIG. 2, for manufacturing surface protection films 1 (FIG. 1) with a topcoat 2 features a four step process. The polyurethane layer 4 may be extruded either on a flat die line or on a blown film line at a thickness usually between 4-12 mils, act 210. The topcoat 2 of acrylic, polyurethane, or Tedlar based topcoat may be applied at a thickness between 0.2-1 mils onto a 0.5-3 mil polyester, polypropylene, or polyethylene carrier by way of gravure, reverse roll, meyer rod, knife-over-roll or transfer coating methods, act 220. The topcoat coated carrier and polyurethane film 4 may be heat laminated together during a separate step at a temperature between approximately 250-450° F., act 230. Finally, the laminate (i.e., the bonded polyurethane 4 and topcoat 2) may be coated on the opposite side of the topcoat 2 with a pressure sensitive adhesive 5 by way of gravure, reverse roll, meyer rod, knife-over-roll, or transfer coating methods and placed on a release layer 7, act 240.

One benefit of laminating the topcoat 2 onto polyurethane film 4, instead of just coating the polyurethane film 4 with a topcoat 2, is that the topcoat 2 takes on the high gloss, smooth surface of the carrier. Having a smooth, high gloss surface protection film may be beneficial because it improves and/or maintains the aesthetics of the surface that the surface protection film 1 is protecting (e.g., a new automobile).

While this process 200 is generally effective, it does suffer from several disadvantages. For example, the process 200 involves four separate and distinct steps and is therefore time consuming. Additionally, the separate step of laminating together the polyurethane layer 4 and the topcoat layer 2 requires heating the polyurethane layer 4 and the topcoat layer 2, thereby adding additional manufacturing costs.

Accordingly, what is needed is an improved method of manufacturing surface protection films having a topcoat. The method should minimize the number of manufacturing steps, thereby reducing the manufacturing time. Additionally, the method should also preferably minimize the manufacturing expenses.

It is important to note that the present disclosure is not intended to be limited to a system or method which must satisfy one or more of any stated objects or features of the invention. It is also important to note that the present disclosure is not limited to the preferred, exemplary, or primary embodiment(s) described herein. Modifications and substitutions by one of ordinary skill in the art are considered to be within the scope of the present disclosure, which is not to be limited except by the following claims.

### SUMMARY

According to one embodiment, the present disclosure features a surface protection film and a method of manufacturing the same. A topcoat layer may be applied to a first surface of a carrier film. The topcoat may be applied using gravure, reverse roll, meyer rod, knife-over-roll or transfer coating methods. A polyurethane layer may be extruded directly onto an exposed surface of the topcoat layer such that the topcoat layer bonds with the polyurethane layer substantially without the need to add additional heat once the polyurethane layer leaves the extruder. An adhesive layer may be applied to a surface of the polyurethane layer generally opposite a side bonded to the topcoat layer. The adhesive layer may be applied using gravure, reverse roll, meyer rod, knife-over-roll or transfer coating methods.

The topcoat layer may be applied to the first surface of the polyurethane layer which may have a temperature of between approximately 250-450° F. The carrier film may be selected from the group consisting of polyester, polypropylene, and polyethylene. Additionally, the carrier film may have a thickness of approximately 0.5 to approximately 3 mils. The topcoat film may have a thickness of between approximately 0.2 to approximately 1 mil.

According to another embodiment, the present disclosure features a method of manufacturing a surface protection film. The method may comprise applying a topcoat layer to a first surface of a carrier film. A polyurethane layer may be extruded directly onto an exposed surface of the topcoat layer such that the topcoat layer bonds with the polyurethane layer without having to separately laminate together the polyurethane layer and the topcoat layer. The topcoat layer may be applied to the first surface of the polyurethane layer which may have a temperature of between approximately 250-450° F. An adhesive layer may be applied to a surface of the polyurethane layer generally opposite a side bonded to the topcoat layer. The carrier film may have a thickness of approximately 0.5 to approximately 3 mils and the topcoat film may have a thickness of between approximately 0.2 to approximately 1 mil.

According to yet another embodiment, the present disclosure features a method of manufacturing a surface protection film consisting essentially of applying a topcoat layer to a first surface of a carrier film, extruding a polyurethane layer directly onto an exposed surface of the topcoat layer at a temperature sufficient for the topcoat layer to bond with the polyurethane layer without the need to perform a separate lamination, and applying an adhesive layer to a surface of the polyurethane layer generally opposite a side bonded to the topcoat layer.

### BRIEF DESCRIPTION OF THE DRAWINGS

These and other features and advantages of the present disclosure will be better understood by reading the following detailed description, taken together with the drawings wherein:

FIG. 1 is a cross-sectional view of one embodiment of a protective film having a topcoat;

FIG. 2 is a flow chart of one embodiment of the prior art method of manufacturing a protective film having a topcoat;

FIG. 3 is a flow chart of one embodiment of the method of manufacturing a protective film having a topcoat according to one embodiment of the present disclosure; and

FIG. 4 is a block diagram of one embodiment of the apparatus for manufacturing a protective film having a topcoat according to one embodiment of the present disclosure.

### DETAILED DESCRIPTION OF THE PREFERRED EMBODIMENTS

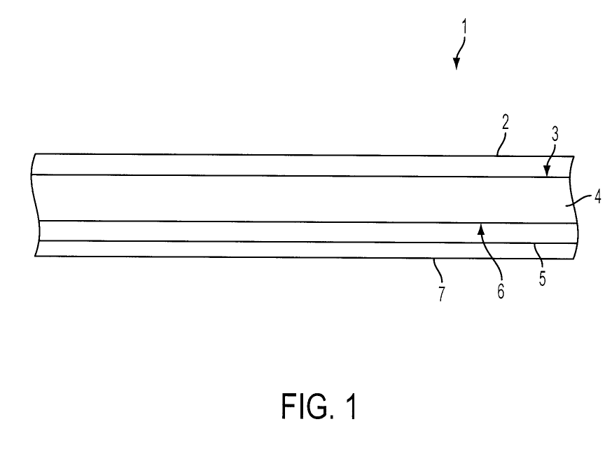

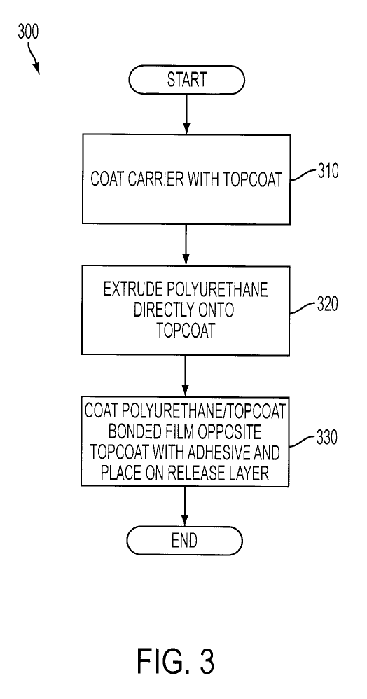

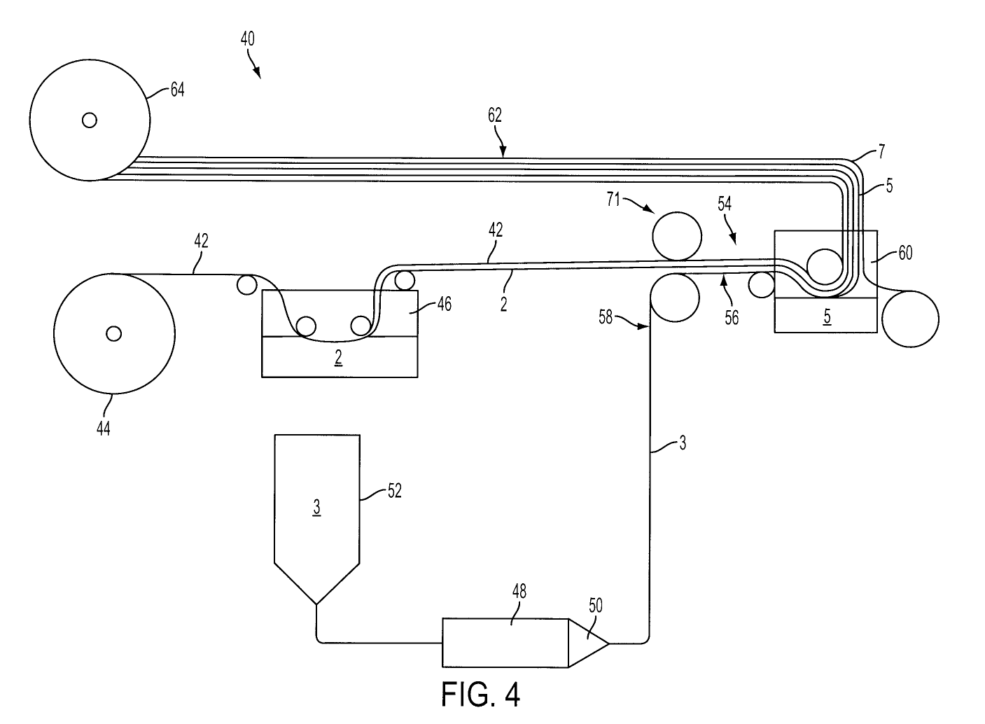

According to one embodiment, the present disclosure features an improved method 300, FIG. 3, and apparatus 40, FIG. 4, for manufacturing a protective film 1, FIG. 1, having a topcoat 2 disposed on a first surface 3 of at least one support layer 3 and a layer 5 of an adhesive disposed on a second surface 6 of the support layer 3. According to one embodiment, the topcoat 2 may include, but is not limited to, an acrylic, a polyurethane, or a fluorinated polymer such as, but not limited to, Tedlar based topcoat having a thickness between approximately 0.2-1 mils. The support layer 3 may include, but is not limited to, a layer of polyurethane having a thickness of approximately 4-12 mils. The adhesive layer 5 may include any adhesive known to those skilled in the art such as, but not limited to, a pressure sensitive adhesive. Those skilled in the art will recognize that other topcoats 2, support layers 3, and adhesives 5 are also possible and are considered within the scope of the present disclosure.

According to one embodiment, the method 300, FIG. 3, and apparatus 40, FIG. 4, may comprise coating a carrier 42 (for example, polyester, polypropylene, polyethylene, treated paper, or the like having a thickness of approximately 1-3 mil) with a layer of a topcoat 2 (act 310). The carrier film 42 may be unwound from a roll 44 or the like. The coating 2 may include any coating 2 known to those skilled in the art, but preferably includes an acrylic, a polyurethane, or Tedlar based topcoat having a thickness between approximately 0.2-1 mils. The topcoat 2 may be applied onto the carrier 42 by way of any method/device 46 known to those skilled in the art such as, but no limited to, preferably gravure, reverse roll, meyer rod, knife-over-roll or transfer coating methods.

A support layer 3 (for example, but not limited to, polyurethane or the like having a thickness of approximately between 4-12 mils) may be extruded directly onto an exposed surface of the topcoat 2 (act 320). The support layer 3 may be extruded any extruder 48 known to those skilled in the art. For example, the extruder 48 may comprise a flat die 50 and that may be fed by a hopper 52 or the like containing the material of the support layer 3. The topcoat 2 may be supported by the carrier 42 and may bond to the support layer 3 (polyurethane film) due to the high temperature/heat of the extruded support layer 3. The support layer 3 may be extruded directly onto the exposed surface of the topcoat layer 2 such that the topcoat layer 2 bonds with the support layer 3 substantially without the need to add additional heat once the support layer 3 leaves the extruder 48 and die 50. Nip and chill rollers 71 may also be used to help bond the support layer 3 to the topcoat layer 2 and to regulate the temperature.

The combination film 54 of the bonded support layer 3 and topcoat 2 may be coated on the uncoated surface 56 of the support layer 3 (i.e., the surface 56 opposite the surface 58 contacting the topcoat 2) with an adhesive layer 5 (preferably a pressure sensitive adhesive). The adhesive layer 5 may optionally be first applied to a release layer 7 (act 330) or may be applied directly to the surface 56 of the support layer 3. The adhesive layer 5 may be applied to either the uncoated surface 56 of the support layer 3 and/or the release layer 7 by way of any method/device 60 known to those skilled in the art. For example, the adhesive layer 5 may be applied using gravure, reverse roll, meyer rod, knife-over-roll, transfer coating methods 60, or the like. While not a limitation unless specifically claimed as such, the adhesive layer 5 may have a thickness ranging between approximately 1.0 mil to approximately 5 mils. The resulting film 62 may then be rolled onto roll 64 and/or cut and packaged.

It should be noted that the adhesive layer 5 may be added substantially simultaneously with extrusion of the support layer 3 and manufacture of the combination film 54. Alternatively, the combination film 54 may be wound onto a roll and the adhesive layer 5 may be added at a later time.

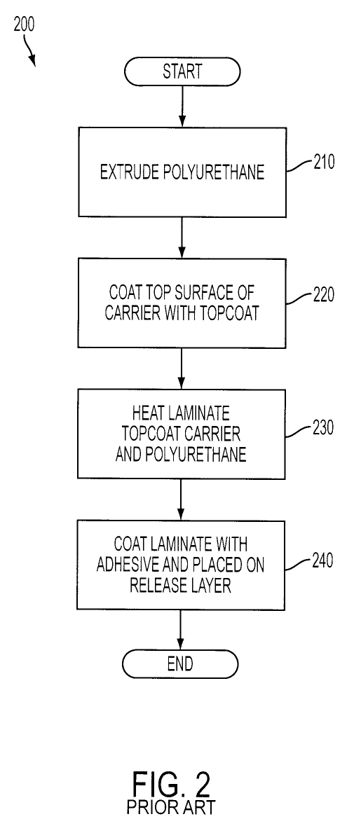

As discussed above, the topcoat 2 forms a very good bond with the support layer 3 because of the high temperature of the extruded support layer 3. In one embodiment, the extruded support layer 3 may include polyurethane having a temperature of approximately 250-450° F. Consequently, the surface of the topcoat 2 according to the present disclosure takes on the smooth, high gloss surface of the carrier 42 while allowing for the elimination of the step of the separate step of laminating the polyurethane film and topcoat together (act 230, FIG. 2) in the prior art. Eliminating the prior art step (act 230, FIG. 2) may make the manufacturing process more cost effective and may reduce the manufacturing time.

As mentioned above, the present disclosure is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

1. A method of manufacturing a surface protection film comprising:
applying a topcoat layer to a first surface of a carrier film; and
extruding a polyurethane layer from an extruder directly onto an exposed surface of said topcoat layer such that said topcoat layer bonds with said polyurethane layer substantially without the need to add additional heat once said polyurethane layer exits said extruder.

2. The method of claim 1 further comprising applying an adhesive layer to a surface of said polyurethane layer generally opposite a side bonded to said topcoat layer.

3. The method of claim 1 wherein said topcoat layer is applied to said first surface of said polyurethane layer having a temperature of between approximately 250-450° F.

4. The method of claim 3 wherein said carrier film is selected from the group consisting of treated paper, polyester, polypropylene, and polyethylene.

5. The method of claim 4 wherein said carrier film has a thickness of approximately 0.5 to approximately 3 mils.

6. The method of claim 5 wherein said topcoat film has a thickness of between approximately 0.2 to approximately 1 mil.

7. The method of claim 1 further comprising applying said topcoat layer using gravure coating.

8. The method of claim 1 further comprising applying said topcoat layer using reverse roll coating.

9. The method of claim 1 further comprising applying said topcoat layer using meyer rod coating.

10. The method of claim 1 further comprising applying said topcoat layer using knife-over-roll coating.

11. The method of claim 1 further comprising applying said topcoat layer using transfer coating.

12. The method of claim 2 further comprising applying said adhesive layer using gravure coating.

13. The method of claim 2 further comprising applying said adhesive layer using reverse roll coating.

14. The method of claim 2 further comprising applying said adhesive layer using meyer rod coating.

15. The method of claim 2 further comprising applying said adhesive layer using knife-over-roll coating.

16. The method of claim 2 further comprising applying said adhesive layer using transfer coating.

17. The protective film according to claim 2.

18. A method of manufacturing a surface protection film comprising:
applying a topcoat layer to a first surface of a carrier film;
extruding a polyurethane layer directly onto an exposed surface of said topcoat layer such that said topcoat layer bonds with said polyurethane layer without having to separately laminate said polyurethane layer and said topcoat layer together.

19. The method of claim 18 further comprising applying an adhesive layer to a surface of said polyurethane layer generally opposite a side bonded to said topcoat layer.

20. The method of claim 18 wherein said topcoat layer is applied to said first surface of said polyurethane layer having a temperature of between approximately 250-450° F.

21. A method of manufacturing a surface protection film consisting essentially of:
applying a topcoat layer to a first surface of a carrier film;
extruding a polyurethane layer directly onto an exposed surface of said topcoat layer at a temperature sufficient for said topcoat layer to bond with said polyurethane layer without the need to perform a separate lamination step; and
applying an adhesive layer to a surface of said polyurethane layer generally opposite a side bonded to said topcoat layer.
